(19) United States
(12) Patent Application Publication
(10) Pub. No.: US 2012/0241489 A1
(43) Pub. Date: Sep. 27, 2012

(54) ELECTRONIC DEVICE WITH STAPLING MECHANISM

(75) Inventor: CHEN-YANG KUO, Tu-Cheng (TW)

(73) Assignee: HON HAI PRECISION INDUSTRY CO., LTD., Tu-Cheng (TW)

(21) Appl. No.: 13/372,584

(22) Filed: Feb. 14, 2012

(30) Foreign Application Priority Data
Mar. 23, 2011 (TW) 100109796

(51) Int. Cl. B65H 37/04; B27F 7/17

(52) U.S. Cl. 227/5; 83/365

(57) ABSTRACT

An electronic device includes a tray, a light source, a sensor, a control module, a puncher assembly and a stapler assembly. The light source is located on the tray and emits light. The sensor is located on the tray and detects a thickness of sheets of paper output from a printer. The control module defines a predetermined height and compares the predetermined height with the thickness of the sheets of paper. The stapler assembly is located on the tray and capable of stapling the sheets of paper. The puncher assembly is located on the tray and can perforate the sheets of papers. If the predetermined height is greater than the difference, the control module drives the stapler assembly to staple the sheets of papers. If the predetermined height is less than or equal to the difference, the control module drives the puncher assembly to perforate the sheets of papers.

### BACKGROUND

1. Technical Field

The present disclosure relates to electronic devices, and particularly to an electronic device with a stapling mechanism.

2. Description of Related Art

Usually, sheets of paper are output from a printer to a paper tray. If the sheets of paper need to be bound together, the output sheets of paper may be taken away from the paper tray and then bound by a stapler, which is time-consuming. Therefore, there is room for improvement in the art.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an exploded, isometric view of an electronic device and sheets of paper in accordance with an embodiment.

FIG. 2 is an assembled view of the electronic device and the sheets of paper of FIG. 1, and a positioning member is not shown.

FIG. 3 is enlarged view of circled portion III of FIG. 2.

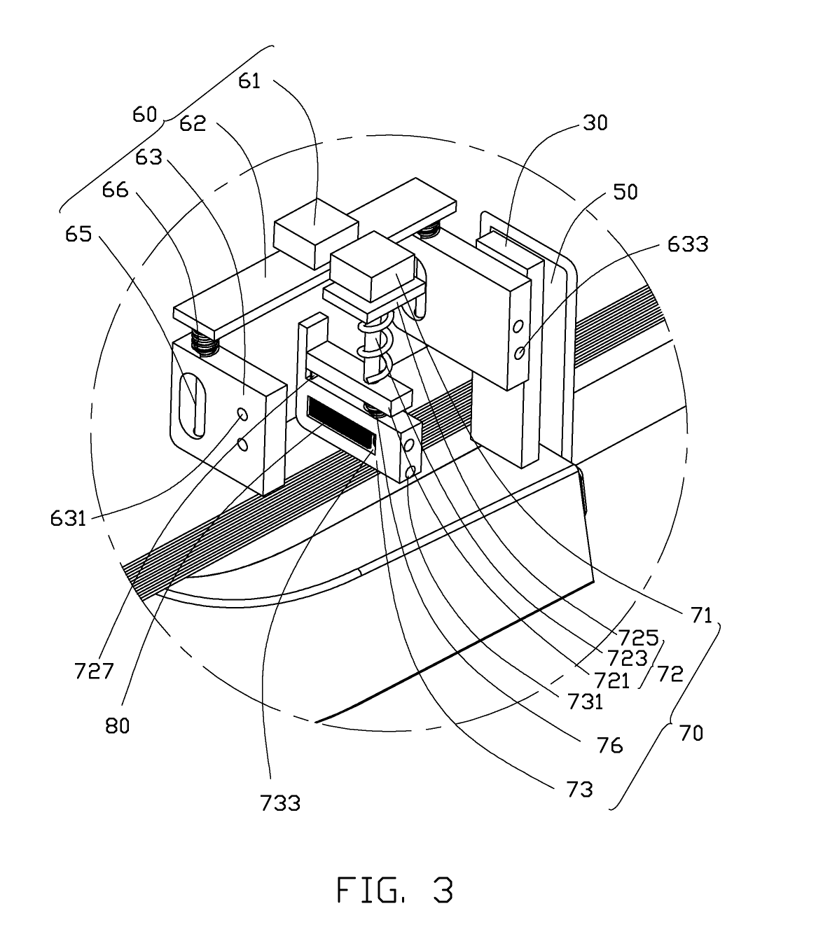

FIG. 4 is an assembled view of the electronic device and the sheets of paper of FIG. 1.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

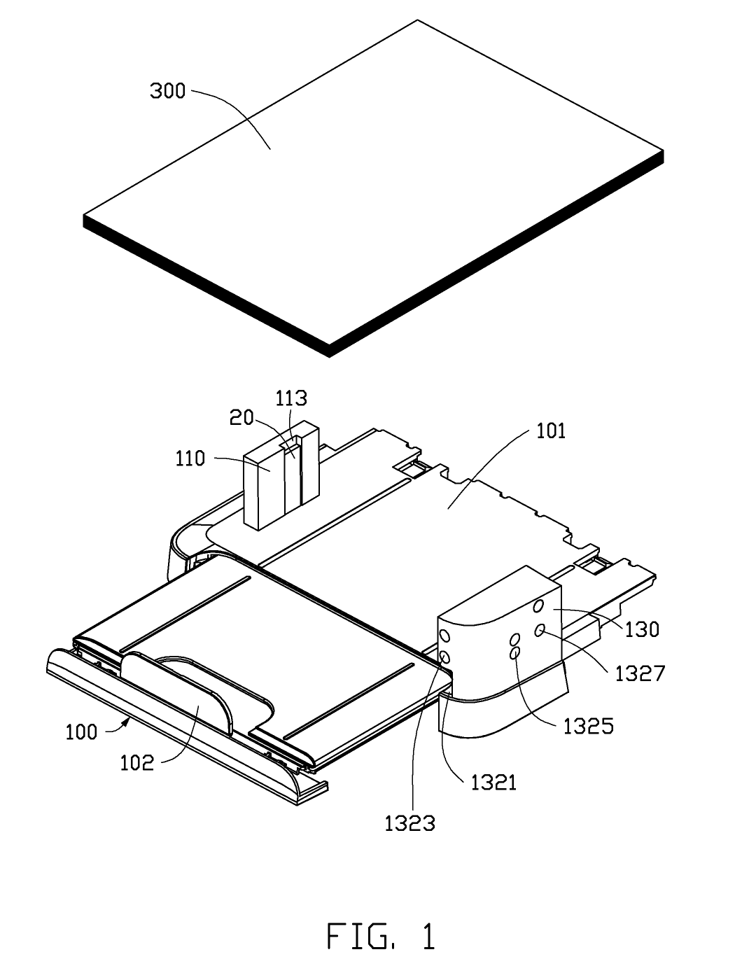

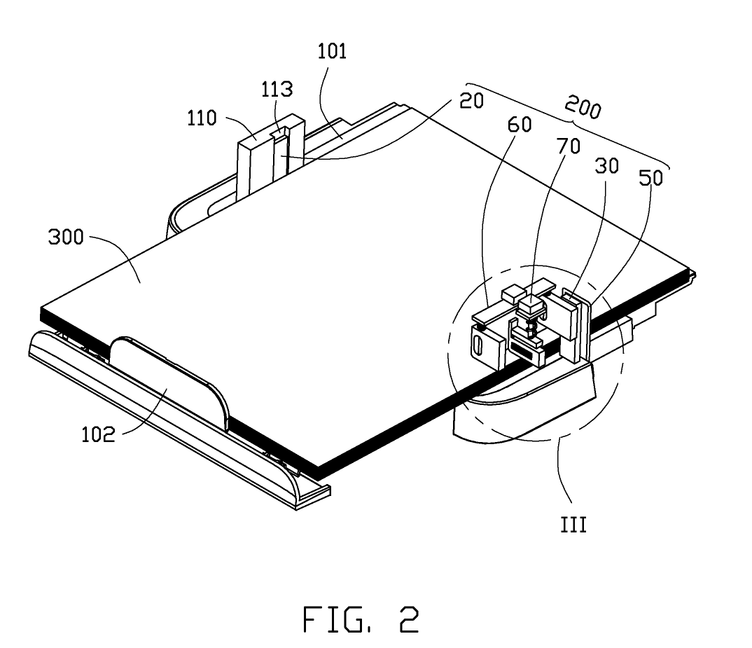

Referring to FIGS. 1-2, an electronic device in accordance with an embodiment includes a tray 100 and a stapling mechanism 200 attached to the tray 100.

The tray 100 is attached to a printer (not shown) for receiving sheets of paper 300 output from the printer. The tray 100 includes a base 101 and a plate 102 attached to a front end of the base 101. A blocking piece 102 is located on a front end of the plate 102, for preventing the sheets of paper 300 from sliding out of the tray 100. A positioning block 110 extends a right side of the base 101, and a positioning member 130 is located on a left side of the base 101. The blocking piece 102, the positioning block 110, and the positioning member 130 are configured together to hold the sheets of paper 300 on the tray 100. A mounting slot 113 is defined in the positioning block 110, facing the positioning member 130. A cutout 1321 is defined in a right side of the positioning member 130, facing the positioning block 110. Two first mounting holes 1323 are defined in a front side of the positioning member 130 above the cutout 1321. Two second mounting holes 1325 and two third mounting holes 1327 are defined in a left side of the positioning member 130.

Referring to FIG. 2, the stapling mechanism 200 includes a light source 20, a sensor 30, a control module 50, a puncher assembly 60, and a stapler assembly 70.

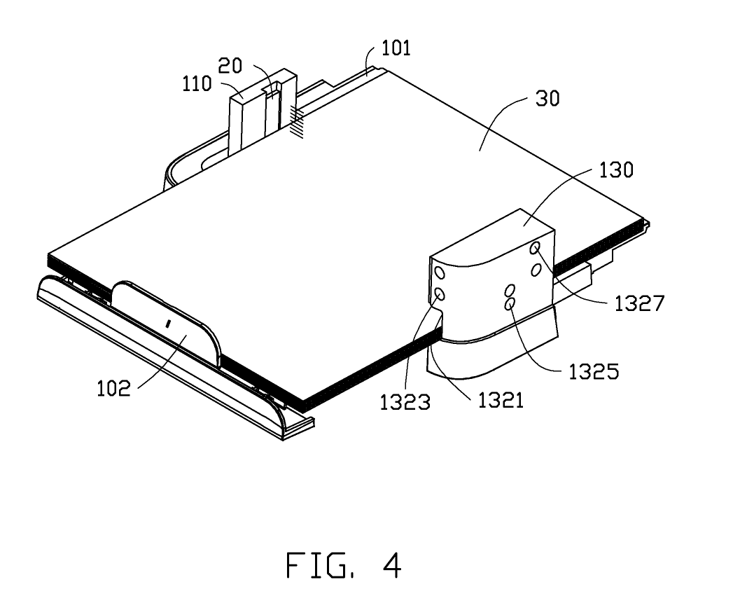

The light source 20, capable of emitting light (arrow shown in FIG. 4), is received in the mounting slot 113. The sensor 30 is capable of sending a signal depending on a height of a surface of the sensor 30, which is irradiated by the light source 20. The control module 50 is capable of controlling operations of the puncher assembly 60 and the stapler assembly 70. A predetermined height is defined by the control module 50.

The puncher assembly 60 includes a first cylinder 61, a first pressing board 62, two first mounting blocks 63, two posts 65, and two first resilient members 66.

One of the two first mounting blocks 63 defines two first securing holes 631 in a first sidewall, and another one of the two first mounting blocks 63 defines two second securing holes 633 in a second sidewall. The first sidewall is substantially perpendicular to the second sidewall. The two posts 65 are fixed to a bottom surface of the first pressing board 62 and extend through each of the two first mounting blocks 63. The two first resilient members 66 are disposed on the two posts 65 between the first pressing board 62 and the two first mounting blocks 63. The first cylinder 61 is located on a top surface of the first pressing board 62.

The stapler assembly 70 includes a second cylinder 71, a pressing member 72, a second mounting block 73, and a second resilient member 76.

The second mounting block 73 defines two third securing holes 731 and a receiving space 733 for receiving a plurality of staples 80. The pressing member 72 is located above the second mounting block 73. The pressing member 72 includes a second pressing board 721, a connecting pole 723, and a retaining board 725. The connecting pole 723 is connected between the second pressing board 721 and the retaining board 725. A pressing piece 727 extends from a bottom surface of the second pressing board 721 and is capable of inserting into the receiving space 733. A second resilient member 76 is located between the top surface of the second mounting block 73 and the second pressing board 721. The second cylinder 71 is located on the retaining board 725.

In assembly, the stapling mechanism 200 is received in the positioning member 130. The two first securing holes 631 are aligned with the two first mounting holes 1323 of the positioning member 130. Two first fasteners (not shown), such as screws, are fixed into the two first securing holes 631 and the two first mounting holes 1323, to secure one of the two first mounting blocks 63 to the positioning member 130. The two second securing holes 633 are aligned with the two third mounting holes 1327. Two second fasteners (not shown), such as screws, are fixed into the two second securing holes 633 and the two third mounting holes 1327, to secure another one of the two first mounting blocks 63 to the positioning member 130. The two third securing holes 731 are aligned with the two second mounting holes 1325. Two third fasteners (not shown), such as screws, are fixed into the two third securing holes 731 and the two second mounting holes 1325, to secure the second mounting block 73 to the positioning member 130.

In use, before the sheets of paper 300 are output from the printer, the light source 20 lights on the sensor 30, and a part of the sensor 30 lighted by the light source 20 defines a first height, thereby the sensor 30 sending a first signal to the control module 50. When the sheets of paper 300 are output from the printer on the tray 100 between the positioning block 110 and the positioning member 130, one end of the sheets of paper 300 are received in the cutout 1321 and located under the two first mounting blocks 63 and the second mounting block 73. A part of the light of the light source 20 are blocked by the sheets of paper 300, and the part of the sensor 30 lighted by the light source 20 defines a second height, thereby the sensor 30 sending a second signal to the control module 50.

The control module 50 calculates a difference between the first height and the second height and compares the difference with the predetermined height. The thickness of the sheets of paper 300 is equal to the difference. If the difference is less than or equal to the predetermined height, the second cylinder 71 drives the control module 50 to slide the pressing member 72 down. The second resilient member 76 is resiliently deformed by the pressing member 72. The pressing piece 727 presses one of the staples 80 to staple the sheets of paper 300. The second cylinder 71 is controlled by the control module 50 to slide the pressing member 72 upward. The second resilient member 76 returns.

If the difference is greater than the predetermined height, the first cylinder 61 is driven by the control module 50 to slide the second pressing board 721 down. The two first resilient members 66 are resiliently deformed by the first pressing board 62. The posts 66 pass through the two first mounting blocks 63 to perforate the sheets of paper 300. The second cylinder 71 is then controlled by the control module 50 to slide upward and separate from the sheets of paper 300. The two first resilient members 66 return.

It is to be understood, however, that even though numerous characteristics and advantages have been set forth in the foregoing description of embodiments, together with details of the structures and functions of the embodiments, the disclosure is illustrative only and changes may be made in detail, especially in matters of shape, size, and arrangement of parts within the principles of the disclosure to the full extent indicated by the broad general meaning of the terms in which the appended claims are expressed.

What is claimed is:

1. An electronic device comprising:
a tray;
a light source located on the tray, the light source capable of emitting light;
a sensor located on the tray, wherein when there are no sheets of paper output from the printer to the tray, the sensor detects a first height, which is defined by a part of the sensor irradiated by the light source; and when there are sheets of paper output from the printer, the sensor detects a second height, which is defined by another part of the sensor irradiated by the light source;
a control module defining a predetermined height, the control module capable of comparing the predetermined height with a difference between the first height and the second height;
a stapler assembly located on the tray, the stapler assembly capable of stapling the sheets of paper; and
a puncher assembly located on the tray, the puncher assembly capable of perforating the sheets of paper; wherein
if the predetermined height is greater than the difference between the first height and the second height, the control module drives the stapler assembly to staple the sheets of paper; if the predetermined height is less than or equal to the difference, the control module drives the puncher assembly to perforate the sheets of paper.

2. The electronic device of claim 1, wherein the stapler assembly and the puncher assembly are located on opposite sides of the tray.

3. The electronic device of claim 1, wherein the puncher assembly comprises a first cylinder, a first pressing board and two posts; the first cylinder and the two posts are located on the first pressing board; and the first cylinder is driven by the control module to slide the first pressing board to push the two posts to perforate the sheets of paper when the predetermined height is less than or equal to the difference between the first height and the second height.

4. The electronic device of claim 3, wherein the puncher assembly further comprises two first mounting blocks, and each of the two posts inserts through each of the two first mounting blocks.

5. The electronic device of claim 4, wherein the puncher assembly further comprises two first resilient members, each of the two first resilient members surrounds each of the two posts, and the two first resilient members are located between the first pressing board and the two first mounting blocks.

6. The electronic device of claim 1, wherein the stapler assembly comprise a second cylinder, a pressing member and a second mounting block; the pressing member is located on the second mounting block; the second mounting block receives a plurality of staples; and the second cylinder is driven by the control module to push the pressing member to urge one of the plurality of staples to staple the sheets of paper when the predetermined height is greater than the difference between the first height and the second height.

7. The electronic device of claim 6, wherein the stapler assembly further comprises a second resilient member located between the second pressing board and the second mounting block.

8. The electronic device of claim 6, wherein the second mounting block defines a receiving space for receiving the plurality of staples.

9. The electronic device of claim 8, wherein a pressing piece is located on the pressing member and extends into the receiving space, and the pressing piece punches one of the plurality of staples to staple the sheets of paper when the pressing member is driven by the control module.

10. The electronic device of claim 2, wherein a positioning block is located on the tray, the positioning block defines a mounting slot, and the light source is mounted in the mounting slot.

11. The electronic device of claim 2, wherein a positioning member is located on the tray, the stapler assembly and the puncher assembly are secured to the positioning member, the positioning member defines a cutout, and the sheets of paper are received in the cutout when the sheets of paper are output to the tray.

12. The electronic device of claim 6, wherein the pressing member comprises a second pressing board, a connecting pole and a retaining board, the connecting pole is connected between the second pressing board and the retaining board, and the second cylinder is located on the retaining board.

13. An electronic device comprising:
a tray;
a light source located on one side of the tray, the light source capable of emitting light;
a sensor located on an opposite side of the tray, the sensor capable of detecting a thickness of sheets of paper output from a printer;
a control module defining a predetermined height, the control module capable of comparing the predetermined height with the thickness of the sheets of paper;
a stapler assembly located on the tray, the stapler assembly capable of stapling the sheets of paper; and
a puncher assembly located on the tray, the puncher assembly capable of perforating the sheets of paper; wherein
if the predetermined height is greater than the thickness of the sheets of paper, the control module drives the stapler assembly to staple the sheets of paper; if the predetermined height is less than or equal to the thickness, the control module drives the puncher assembly to perforate the sheets of paper.

14. The electronic device of claim 13, wherein the puncher assembly comprises a first cylinder, a first pressing board and two posts; the first cylinder and the two posts are located on the first pressing board; and the first cylinder is driven by the control module to slide the first pressing board to push the two posts to perforate the sheets of paper when the predetermined height is less than or equal to the thickness of the sheets of paper.

15. The electronic device of claim 14, wherein the puncher assembly further comprises two first mounting blocks, and each of the two posts inserts through each of the two first mounting blocks.

16. The electronic device of claim 15, wherein the puncher assembly further comprises two first resilient members, each of the two first resilient members surrounds each of the two posts, and the two first resilient members are located between the first pressing board and the two first mounting blocks.

17. The electronic device of claim 13, wherein the stapler assembly comprise a second cylinder, a pressing member and a second mounting block, the pressing member is located on the second mounting block, the second mounting block receives a plurality of staples, the second cylinder is driven by the control module to push the pressing member to urge the one of the plurality of staples to staple the sheets of paper when the predetermined height is greater than the thickness of the sheets of paper.

18. The electronic device of claim 17, wherein the stapler assembly further comprises a second resilient member located between the pressing member and the second mounting block.

19. The electronic device of claim 17, wherein the second mounting block defines a receiving space for receiving the plurality of staples.

20. The electronic device of claim 17, wherein a pressing piece is located on the pressing member and extends into the receiving space, and the pressing piece punches the one of the plurality of staples to staple the sheets of paper when the pressing member is driven by the control module.
